(19) United States
(12) Patent Application Publication
(10) Pub. No.: US 2023/0052447 A1
(43) Pub. Date: Feb. 16, 2023

(54) Apparatus and Method for Measuring Pressure of Battery Cells

(71) Applicant: LG Energy Solution, Ltd., Seoul (KR)

(72) Inventors: Ki Young Lee, Daejeon (KR); Dong Wan Ko, Daejeon (KR); Doyul Kim, Daejeon (KR)

(73) Assignee: LG Energy Solution, Ltd., Seoul (KR)

(21) Appl. No.: 17/789,594

(22) PCT Filed: Dec. 8, 2020
(86) PCT No.: PCT/KR2020/017808

§ 371 Date: Jun. 28, 2022

(30) Foreign Application Priority Data
Jun. 3, 2020 (KR) 10-2020-0067005

(51) Int. Cl. G01L 17/00; G01L 9/00

(52) U.S. Cl. CPC G01L 17/005; G01L 9/0002

(57) ABSTRACT

An apparatus for measuring a pressure of battery cells includes a pressure sensor configured to measure the pressure of battery cells stacked in the interior of a battery module, the pressure sensor includes a plurality of pressure measuring units, a connection unit for connecting the plurality of pressure measuring units to each other, and an output unit connected to the connection unit and configured to output pressure values measured through the pressure measuring units, and the plurality of pressure measuring units are arranged on surfaces of the battery cells to measure the pressure of the battery cells.

### CROSS-REFERENCE TO RELATED APPLICATIONS

The present application is a national phase entry under 35 U.S.C. § 371 of International Application No. PCT/KR2020/017808 filed Dec. 8, 2020, which claims priority from Korean Patent Application No. 10-2020-0067005 filed Jun. 3, 2020, all of which are incorporated herein by reference.

### TECHNICAL FIELD

The present disclosure relates to an apparatus and a method for measuring a pressure of battery cells, and more particularly to an apparatus and a method for measuring a pressure of battery cells, which can measure the pressure of battery cells when a swelling phenomenon of the battery cell occurs.

### BACKGROUND ART

A secondary battery has attracted much attention as an energy source in various products such as a mobile device and an electric vehicle. The secondary battery is a potent energy resource that can replace the use of existing products using fossil fuels, and is in the spotlight as an environment-friendly energy source because it does not generate by-products due to energy use.

Recently, along with a continuous rise of the necessity for a large-capacity secondary battery structure, including the utilization of the secondary battery as an energy storage source, there is a growing demand for a battery pack of a multi-module structure which is an assembly of battery modules in which a plurality of secondary batteries are connected in series/parallel.

Meanwhile, when a plurality of battery cells are connected in series/parallel to configure a battery pack, it is common to configure a battery module composed of at least one battery cell first, and then configure a battery pack by using at least one of the battery modules and adding other components. The battery pack may be used mainly as an energy source of an electric vehicle.

When designing such a battery module, it has been developed by pressing the battery cells at a constant pressure and thus, the battery cells are swelled in the process of repeating charging and discharging. However, as the battery cells are swelling, there is a concern that swelling may occur to such an extent as to push out the surrounding module frame and battery pack case.

Therefore, if the pressure of battery cells can be measured, action can be taken through the measured pressure before the appearance of the battery module or the battery pack is deformed, thereby securing the safety of the battery module and the battery pack. At this time, the swelling pressure of the battery cells can be measured by using pressure sensors, but in the case of the RSR (Force-Sensing Resistor) sensor, which has previously been often used as a pressure sensor, there is a problem it is small in size and thus dose not measure all the swelling pressures generated on the entire surface of the battery cells.

Further, when the size of the FSR sensor is made larger in compliance with the surface size of the battery cells, a spacer that supports an upper plate and a lower plate between the upper plate and the lower plate no longer supports the upper plate and the lower plate, which causes a problem that the swelling pressure of the battery cells are not accurately measured.

### SUMMARY

### Technical Problem

It is an object of the present disclosure to provide an apparatus and a method for measuring a pressure of battery cells, which can accurately measure a swelling pressure of battery cells.

The objects of the present disclosure are not limited to the aforementioned objects, and other objects which are not described herein should be clearly understood by those skilled in the art from the following detailed description.

### Technical Solution

In order to achieve the above objects, one embodiment of the present disclosure provides an apparatus and a method for measuring a pressure of battery cells, the apparatus comprising: a pressure sensor array configured to measure a pressure of a plurality of battery cells stacked in an interior of a battery module, wherein the pressure sensor array comprises a plurality of pressure sensors, and a transmitter connected to the plurality of pressure sensors and configured to output one or more pressure values measured through the plurality of pressure sensors, wherein the plurality of pressure sensors are arranged on surfaces of the plurality of battery cells to measure the pressure of the plurality of battery cells.

Each pressure sensor may be configured to measure a respective pressure value, and the transmitter may be configured to output a sum of the measured pressure values measured through the plurality of pressure sensors.

Each of the plurality of pressure sensors may include a current input connection and a current output connection, and the transmitter may be connected to the plurality of current input connections and the plurality of current output connections and may be configured to output the one or more pressure values measured by the plurality of pressure sensors.

The plurality of pressure sensors on the surface of a battery cell of the plurality of battery cells may be arranged in a rectangular grid.

Each of the plurality of pressure sensors may be circular and may be arranged in the pressure sensor array according to a pattern.

A system including the apparatus as described in any of the embodiments herein and the plurality of battery cells, each battery cell of the plurality of battery cells including a cell body, a cell terrace, and an electrode lead, wherein the plurality of pressure sensors may be arranged on a body surface of the cell body of one or more of the plurality of battery cells.

A method for measuring a pressure of a plurality of battery cells may include the steps of applying a pressure to a pressure sensor while the plurality of battery cells are swelled, transferring sensing information of the pressure sensor to a battery management system (BMS), and transferring the sensing information from a micro controller unit (MCU) inside the BMS to an electric control unit (ECU) or a user.

The step of transferring sensing information to the BMS may include transmitting a warning signal in response to a resistance value of the pressure sensor being 100,000 Ohm or less.

The step of transferring sensing information to the BMS may include transmitting a danger signal in response to a resistance value of the pressure sensor being 10,000 Ohm or less.

The method for measuring the pressure of the battery cell may further include a step of setting a resistance value of the pressure sensor to be infinite, before the step of apply the pressure to the pressure sensor while the battery cell is swelled.

### Advantageous Effects

The apparatus and method for measuring a pressure of battery cells according to an embodiment of the present disclosure can cope with a swelling phenomenon of battery cells and measure the swelling pressure of the battery cells more accurately, by disposing a plurality of pressure measuring units on the surfaces of the battery cells and measuring the pressure of the battery cells.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is an exploded perspective view illustrating a battery module including battery cells;

FIG. 2 is a view illustrating a battery cell of FIG. 1;

FIG. 3 is a view illustrating a state in which an apparatus for measuring a pressure of battery cells according to an embodiment of the present disclosure is formed on the body surface of the cell body of FIG. 2;

FIG. 4 is a view illustrating a configuration of a FSR sensor according to a comparative example of the present disclosure;

FIG. 5 is a view illustrating a shape in which a plurality of FSR sensors according to the comparative example of the present disclosure are attached to the surface of battery cells; and

FIG. 6 is a flowchart illustrating a method for measuring a pressure of battery cells according to an embodiment of the present disclosure.

### DETAILED DESCRIPTION

It should be appreciated that the exemplary embodiments, which will be described below, are illustratively described to help understand the present disclosure, and the present disclosure may be variously modified to be carried out differently from the exemplary embodiments described herein. However, in the description of the present disclosure, the specific descriptions and illustrations of publicly known functions or constituent elements will be omitted when it is determined that the specific descriptions and illustrations may unnecessarily obscure the subject matter of the present disclosure. In addition, in order to help understand the present disclosure, the accompanying drawings are not illustrated based on actual scales, but parts of the constituent elements may be exaggerated in size.

As used herein, terms such as first, second, and the like may be used to describe various components, and the components are not limited by the terms. The terms are used only to discriminate one component from another component.

Further, the terms used herein are used only to describe specific exemplary embodiments, and are not intended to limit the scope of the present disclosure. A singular expression includes a plural expression unless they have definitely opposite meanings in the context. It should be understood that the terms “comprise”, “include”, and “have” as used herein are intended to designate the presence of stated features, numbers, steps, constitutional elements, or combinations thereof, but it should be understood that they do not preclude a possibility of existence or addition of one or more other features, numbers, steps, constitutional elements, or combinations thereof.

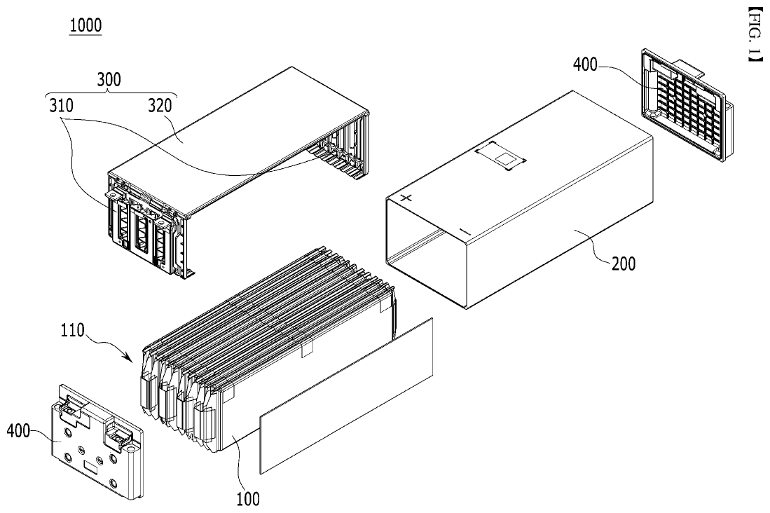

Hereinafter, an apparatus for measuring a pressure of battery cells according to an embodiment of the present disclosure will be described with reference to FIGS. 1 to 3.

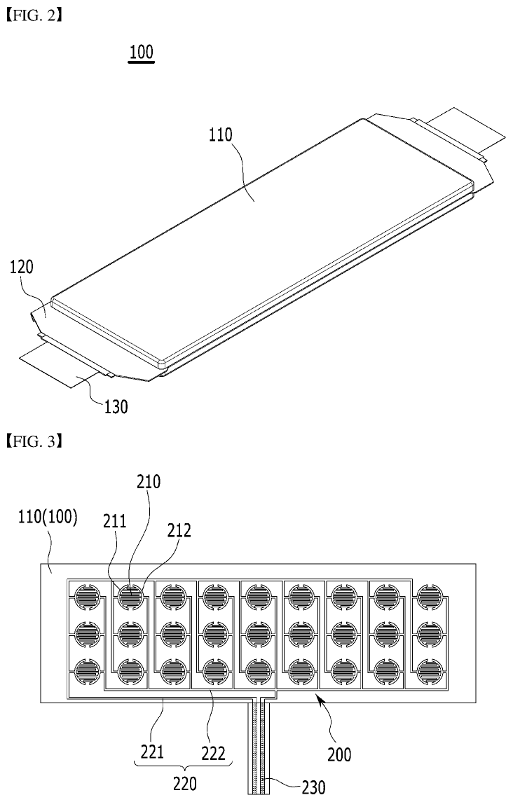

FIG. 1 is an exploded perspective view illustrating a battery module including battery cells. FIG. 2 is a view illustrating the battery cell of FIG. 1. FIG. 3 is a view illustrating a state in which an apparatus for measuring a pressure of battery cells according to an embodiment of the present disclosure is formed on the body surface of the cell body of FIG. 2.

Referring to FIGS. 1 to 3, an apparatus for measuring a pressure of battery cells according to an embodiment of the present disclosure includes a pressure sensor 200 configured to measure the pressure of battery cells 100 stacked in the interior of a battery module 1000. The pressure sensor 200 includes a plurality of pressure measuring units 210, a connection unit 220 connecting the plurality of pressure measuring units 210 to each other, and an output unit 230 connected to the connection unit 220 and configured to output pressure values measured through the pressure measuring units 210. The plurality of pressure measuring units 210 are arranged on surfaces of the battery cells 100 to measure the pressures of the battery cells 100.

The battery cell 100 is a secondary battery, and may be configured of a pouch type secondary battery. The battery cells 100 may be formed of a plurality of battery cells and the plurality of the battery cells may be stacked together so as to be electrically connected to each other, thereby forming the battery cell stack 101.

A module frame 500 can house the battery cell stack 101 and a busbar frame assembly 300 to protect electronic components constituting the battery module from the outside.

The busbar frame assembly 300 may include busbar frames 310 configured to cover front and rear surfaces of the battery cell stack 101, and an upper plate 320 configured to connect two busbar frames 310 on an upper surface of the battery cell stack 101. The busbar frame 310 can electrically connect an electrode lead formed in the battery cell 100 and the busbar through a busbar mounted on the busbar frame 310. A connection unit (not illustrated) may be formed at a lower side of the upper plate 320 to electrically connect the busbar frames 310 formed at both ends of the battery cell stack 101. The busbar frame assembly 300 may be coupled to the front and rear surfaces and the upper surface of the battery cell stack 101.

End plates 400 may be disposed so as to cover the front and rear surfaces of the battery cell stack 101. The end plates 400 may be coupled to edge portions of the module frame 500 through welding.

The battery cells 100 disposed in the battery module 1000 occurs a swelling phenomenon, in which expands the volumes of the battery cells 100 expand while repeating charging and discharging, and due to the swelling of the battery cells, deformation may be occurred in the battery module and a battery pack on which the battery module is mounted. Therefore, before the battery module and the battery pack are deformed, it is possible to measure a swelling pressure and take a pretreatment based on the measured pressure value.

FIG. 4 is a view illustrating a configuration of a FSR sensor according to a comparative example the present disclosure.

When the swelling pressure of the battery cells is measured, the FSR sensor 10 illustrated in FIG. 4 can be used, and the FSR sensor 10 may include a measuring unit 11 configured to measure the pressure and an output unit 12 configured to transmit the measured pressure value to the outside. However, in the case of the FSR sensor 10, there is a problem that the size is very small and a measurable range thereof is narrow. Further, when the size of the FSR sensor 10 is simply made large to correspond to a surface of the battery cell, it is difficult for a spacer 11C formed in the interior of the FSR sensor 10 to support an upper plate 11B and a lower plate 11A of the FSR sensor 10, thereby making it difficult to measure a proper pressure because a middle part of the upper plate is deflected to the lower side.

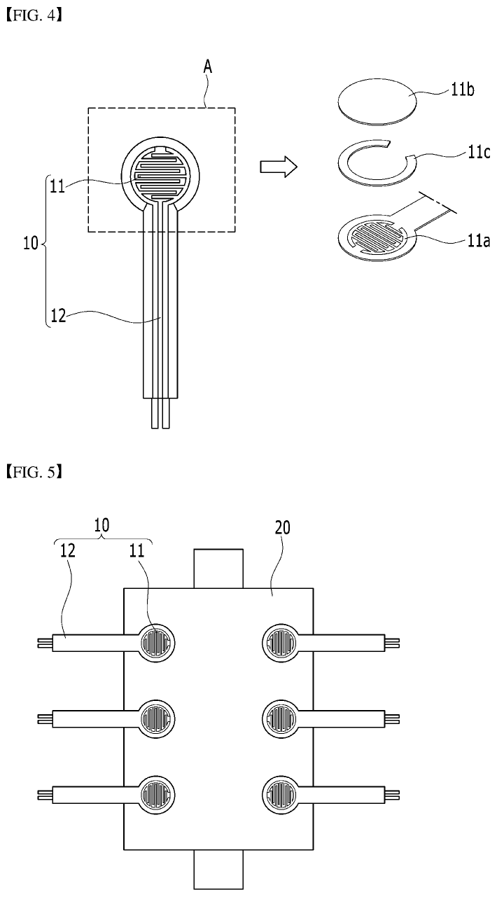

FIG. 5 is a view illustrating a state in which a plurality of FSR sensors according to the comparative example of the present disclosure are attached to the surface of battery cells.

Further, when the FSR sensors 10 are independently installed in respective areas of one battery cell 20 to measure a pressure of the battery cell as illustrated in FIG. 5, a plurality of FSR sensors 10 are necessary, and the plurality of FSR sensors 10 have to be installed in all of the respective areas. Therefore, many measuring devices are necessary, and the measured values are separately outputted through the output units 12 formed for the respective FSR sensors 10, thereby making it difficult to arrange the output values.

Thus, according to the present embodiment, the plurality of pressure measuring units 210 are arranged in rectangular grids on the surface of the battery cells 100 and the pressure measuring units 210 are connected to each other by the connection unit 220 to cover all ranges of the surfaces of the battery cells. Further, because the connection unit 220 is connected to one output unit 230, the pressure values measured through the plurality of the pressure measuring units 210 may be summed up into one output value through the output unit 230 formed of one, so that it easier to detect the swelling pressure.

Referring to FIG. 2, the battery cell 100 may include a cell body 110, a cell terrace 120, and an electrode lead 130, and the plurality of pressure measuring units 210 may be arranged on the body surface of the cell body 110.

Each of the plurality of pressure measuring units 210 may include a current input unit 211 and a current output unit 212, and the connection unit 220 may include a current input side connection unit 221 for connecting the current input units 211, and a current output side connection unit 222 connecting the current output units 212. Here, the output unit 230 may be connected to the current input side connection unit 221 and the current output side connection unit 222 to output the pressure value measured from the plurality of pressure measuring units.

The plurality of pressure measuring units 210 may have a circular shape having a pattern. In more detail, referring to FIG. 3, the current input side connection unit 221 and the current output side connection unit 222 may form an outskirt of the pressure measuring unit 210 of a circular shape and sensing units extending from the current input side connection unit 221 and the current output side connection unit 222 may form a pattern of the interior of a circular shape.

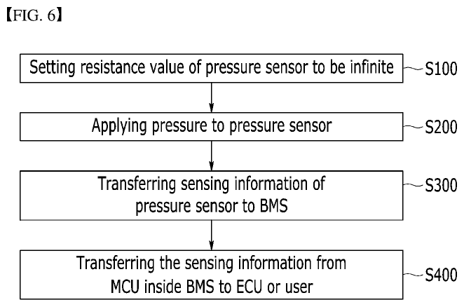

Hereinafter, a method for measuring a pressure of battery cells according to an embodiment of the present disclosure will be described with reference to FIG. 6.

FIG. 6 is a flowchart illustrating a method for measuring a pressure of battery cells according to the embodiment of the present disclosure.

Referring to FIGS. 3 and 6, the method for measuring the pressure of battery cells includes a step of applying a pressure to a pressure sensor 200 while a battery cell 100 is swelled (S200), a step of transferring sensing information of the pressure sensor 200 to a BMS (battery management system) (S300), and a step of transferring the sensing information from a MCU (micro controller unit) inside the BMS to a user or an ECU (electric control unit) (S400). In more detail, in a battery cell for a vehicle, sensing information from the MCU may be transferred to the ECU of the vehicle, and in a battery cell for an ESS (energy storage system), sensing information from the MCU may be transferred to a user.

Swelling information measured from the pressure sensor 200 may be transferred to a user so that the user can take a pretreatment on a product before the battery module and the battery pack are deformed.

According to the present embodiment, in the step of transferring sensing information to a BMS, a warning signal may be transmitted when a resistance value of the pressure sensor 200 is 100,000 Ohm or less. Further, a danger signal may be transmitted when a resistance value of the pressure sensor 200 is 10,000 Ohm or less. This means that the pressure acts on the pressure sensor 200 more strongly as the resistance value decreases. Further, as the resistance value of the pressure sensor 200 decreases, the type of the signal depending on the swelling becomes different, so that a user can immediately recognize the danger level depending on the level of swelling according to the type of the signal in advance.

In order to exactly transmit signals of the pressure sensor, the method for measuring the pressure of the battery cell may further include a step of setting a resistance value of the pressure sensor to be infinite (S100) before the step of applying the pressure to the pressure sensor 200 while the battery cell 100 is swelled (S200). When the resistance value is infinite, it may mean that no pressure is acted, and when the resistance value decreases, it may mean that the pressure is increasingly acting on the pressure sensor 200.

The above-mentioned battery module may be included in the battery pack. The battery pack may have a structure in which one or more of the battery modules according to the present embodiment are gathered, and packed together with a battery management system (BMS) and a cooling device that control and manage battery's temperature, voltage, etc.

The battery pack can be applied to various devices. Such a device may be applied to a transportation means such as an electric bicycle, an electric vehicle, or a hybrid vehicle, but the present disclosure is not limited thereto, and is applicable to various devices that can use a battery module, which also belongs to the scope of the present disclosure.

Although the invention has been shown and described with reference to the preferred embodiments, the scope of the present disclosure is not limited thereto, and numerous other modifications and embodiments can be devised by those skilled in the art that will fall within the spirit and scope of the principles of the invention described in the appended claims. Further, these modified embodiments should not be understood individually from the technical spirit or perspective of the present disclosure.

### DESCRIPTION OF REFERENCE NUMERALS

100: battery cell
101: battery cell stack
110: cell body
120: cell terrace
130: electrode lead
200: pressure sensor
210: pressure measuring unit
211: current input unit
212: current output unit
220: connection unit
221: current input side connection unit
222: current output side connection unit
230: output unit
300: busbar frame assembly
310: busbar frame
320: upper plate
400: end plate
500: module frame
1000: battery module

1. An apparatus comprising:
a pressure sensor array configured to measure a pressure of a plurality of battery cells stacked in an interior of a battery module, wherein the pressure sensor array comprises a plurality of pressure sensors;
a transmitter connected to the plurality of pressure sensors and configured to output one or more pressure values measured through the plurality of pressure sensors,
wherein the plurality of pressure sensors are arranged on surfaces of the plurality of battery cells to measure the pressure of the plurality of battery cells.

2. The apparatus according to claim 1,
wherein each pressure sensor is configured to measure a respective pressure value, and wherein the transmitter is configured to output a sum of the measured pressure values measured through the plurality of pressure sensors.

3. The apparatus according to claim 1,
wherein each of the plurality of pressure sensors comprises a current input connection and a current output connection,
wherein the transmitter is connected to the plurality of current input connections and the plurality of current output connections and is configured to output the one or more pressure values measured by the plurality of pressure sensors.

4. A system comprising:
the apparatus according to claim 1; and
the plurality of battery cells, wherein each battery cell of the plurality of battery cells comprises a cell body, a cell terrace, and an electrode lead, and
wherein the plurality of pressure sensors are arranged on a body surface of the cell body of one or more of the plurality of battery cells.

5. The apparatus according to claim 1,
wherein the plurality of pressure sensors on the surface of a battery cell of the plurality of battery cells are arranged in a rectangular grid.

6. The apparatus according to claim 1,
wherein each of the plurality of pressure sensors is circular, and wherein the plurality of pressure sensors are arranged in the pressure sensor array according to a pattern.

7. A method for measuring a pressure of a plurality of battery cells, the method comprising:
applying a pressure to a pressure sensor while the plurality of battery cells are swelled;
transferring sensing information of the pressure sensor to a (battery management system (BMS); and
transferring the sensing information from a (micro controller unit (MCU) inside the BMS to an (electric control unit (ECU) or a user.

8. The method according to claim 7,
wherein transferring sensing information to the BMS comprises transmitting a warning signal in response to a resistance value of the pressure sensor being 100,000 Ohm or less.

9. The method according to claim 7,
wherein transferring a-sensing information to the BMS comprises transmitting a danger signal in response to a resistance value of the pressure sensor being 10,000 Ohm or less.

10. The method according to claim 7,
further comprising setting a resistance value of the pressure sensor to be infinite, before applying the pressure to the pressure sensor while the battery cell is swelled.
